(19) United States
(12) Patent Application Publication
(10) Pub. No.: US 2010/0275264 A1
(43) Pub. Date: Oct. 28, 2010

(54) COMPUTER FOR CONTROLLING STORAGE SYSTEM PROVIDED WITH ENCRYPTION/DECRYPTION FUNCTION

(75) Inventor: Yusuke Masuyama, Yokohama (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/490,982

(22) Filed: Jun. 24, 2009

(30) Foreign Application Priority Data
Apr. 23, 2009 (JP) 2009-103972

(51) Int. Cl. H04L 9/00; G06F 12/14; G06F 13/00

(52) U.S. Cl. 726/26; 713/193; 380/44; 711/162

(57) ABSTRACT

A computer is coupled to at least one E/D storage (a storage system provided with an encryption/decryption function). A computer determines whether or not a security policy related to a copy destination VOL is equal to a security policy related to a copy source VOL based on the control information that includes information associated with a security policy related to a copy source VOL and a copy destination VOL. In the case in which a result of the determination is positive, the computer specifies an encryption key/decryption key related to a copy source VOL as an encryption key/decryption key related to a copy destination VOL to an E/D storage provided with a copy destination VOL (a copy destination storage). The computer then indicates a read and an undecryption of data that has been stored into a copy source VOL to an E/D storage provided with a copy source VOL, and indicates a write and an unencryption of the read data to a copy destination storage.

### CROSS-REFERENCE TO PRIOR APPLICATION

This application relates to and claims the benefit of priority from Japanese Patent Application number 2009-103972, filed on Apr. 22, 2009 the entire disclosure of which is incorporated herein by reference.

### BACKGROUND

The present invention generally relates to a control of a storage system provided with an encryption/decryption function.

A storage system that encrypts a write target data from a host and that stores the data in a logical volume (hereafter referred to as a VOL) is publicly known (see Patent Citation 1 for instance). Hereafter, a function for encrypting data to be written to a VOL is referred to as an “encryption function”, and a function for decrypting the encrypted data (data that has been encrypted) that has been read from a VOL is referred to as a “decryption function”. Moreover, an encryption and/or a decryption can be referred to as “E/D” in some cases.

A technique for carrying out a data copy between VOLs (hereafter referred to as a VOL copy) is also publicly known. In the VOL copy, data is read from a copy source VOL, and the data is written to a copy destination VOL.

As a VOL copy, a local copy and a remote copy can be mentioned (see Patent Citation 2 and Patent Citation 3 for instance). A local copy is a data copy between VOLs in one storage system. A remote copy is a data copy from a copy source VOL in a first storage system to a copy destination VOL in a second storage system.

Moreover, as a VOL copy, a data migration between VOLs can be mentioned (see Patent Citation 4 for instance). In general, data that has been copied is deleted from a copy source VOL in a data migration.

### [Patent Citation 1]

### Japanese Patent No. 3911964

### [Patent Citation 2]

### Japanese Patent Application Laid-Open Publication No. 2008-134988

### [Patent Citation 3]

### Japanese Patent Application Laid-Open Publication No. 2008-134986

### [Patent Citation 4]

### Japanese Patent No. 3641872

### SUMMARY

A copy source VOL is set to be a VOL in a storage system provided with an E/D function (hereafter referred to as an E/D storage), and a copy destination VOL is set to be a VOL in the E/D storage or another E/D storage.

The E/D storage encrypts data that is written to a VOL, and decrypts the encrypted data that has been read from a VOL (see Patent Citation 1 described above).

Consequently, in a copy of data from a copy source VOL to a copy destination VOL, the encrypted data that has been read from a copy source VOL is decrypted, and the decrypted data is encrypted again and is written to a copy destination VOL. Therefore, a load of a VOL copy in at least one E/D storage becomes high.

An object of the present invention is to reduce a load of a volume copy in at least one storage system provided with an encryption/decryption function.

A computer is coupled to at least one E/D storage. A computer determines whether or not a security policy related to a copy destination VOL is equal to a security policy related to a copy source VOL based on the control information that includes information associated with a security policy related to a copy source VOL and a copy destination VOL. In the case in which a result of the determination is positive, the computer configures an encryption key/a decryption key related to a copy source VOL as an encryption key/a decryption key related to a copy destination VOL to an E/D storage provided with a copy destination VOL (a copy destination storage). The computer then indicates a copy of data from a copy source VOL to a copy destination VOL, and an unencryption and an undecryption to a copy source storage and/or a copy destination storage.

### BRIEF DESCRIPTION OF THE DRAWINGS

FIG. 1 shows an outline in accordance with an embodiment of the present invention.

FIG. 2A shows a hardware configuration of a management server 201.

FIG. 2B shows a configuration of an E/D storage 205.

FIG. 3 shows an example of computer programs that are executed by a management server 201, data to be used in the server 201, and a data center.

FIG. 4A shows a center SEC table 401.

FIG. 4B shows a SEC/center table 402.

FIG. 4C shows a server group SEC table 403.

FIG. 4D shows a SEC/server group table 404.

FIG. 5A shows a center table 501.

FIG. 5B shows a center/server group table 502.

FIG. 5C shows a center/storage table 503.

FIG. 6A shows a business server group table 601.

FIG. 6B shows a business server table 602.

FIG. 6C shows a key table 603.

FIG. 6D shows a key assignment table 604.

FIG. 7A shows a storage table 701.

FIG. 7B shows an E/D controller table 702.

FIG. 7C shows a VOL table 703.

FIG. 7D shows a path table 704.

FIG. 8 illustrates a processing that is carried out by a controller (CTL) #1 included in an E/D storage #1 of a copy source and a processing that is carried out by a controller (CTL) #100 included in an E/D storage #100 of a copy destination.

FIG. 9 shows a flow of a copy control processing.

### DETAILED DESCRIPTION

An embodiment in accordance with the present invention will be described below in detail with reference to the drawings. In the following descriptions, a logical volume can be also referred to as a “VOL”, and a storage system provided with an encryption/decryption function can be referred to as an “E/D storage” in some cases. A processor in the following descriptions is a microprocessor such as a CPU in a typical way.

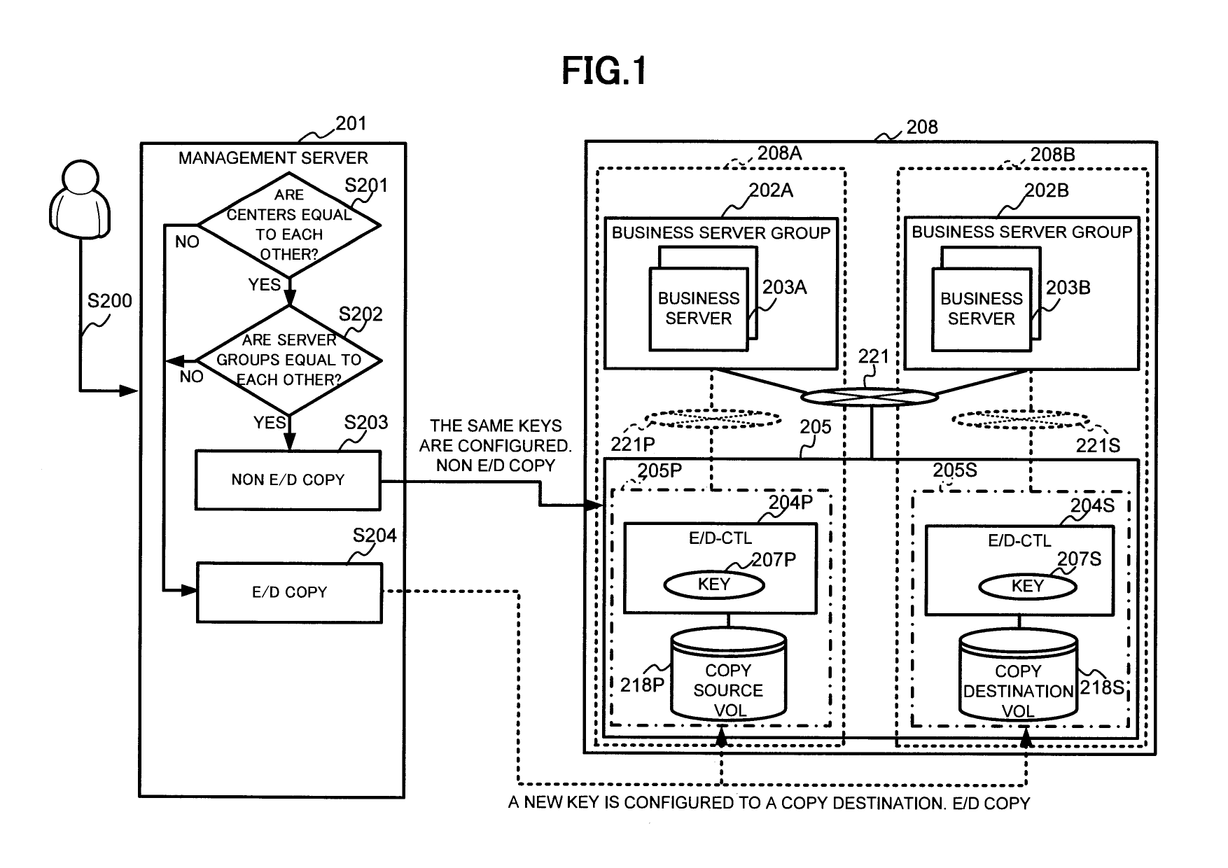

FIG. 1 shows an outline in accordance with an embodiment of the present invention.

The embodiment of the present invention is provided with a copy source VOL 218P and a copy destination VOL 218S. There is a case in which the copy source VOL 218P and the copy destination VOL 218S exist in one data center 208. In addition, there is a case in which the copy source VOL 218P exists in a first data center 208A and the copy destination VOL 218S exists in a second data center 208B. Hereafter, the former case is referred to as a “first case”, and the latter case is referred to as a “second case”.

The data center 208, 208A, 208B is provided with a business server group and an E/D storage.

More specifically, in the first case, the data center 208 is provided with at least one (for instance two) business server groups 202A and 202B and an E/D storage 205 for instance. In this case, both the copy source VOL 218P and the copy destination VOL 218S are included in a plurality of VOLs included in the E/D storage 205. The business server groups 202A and 202B access a VOL in the E/D storage 205 via a storage network 221. The storage network is a first communication network, for instance a communication network in which a communication is carried out by an FC protocol (such as a SAN (Storage Area Network)).

In the second case, the first data center 208A is provided with at least one (for instance one) business server group 202A and a first E/D storage 205P, and the second data center 208B is provided with at least one (for instance one) business server group 202B and a second E/D storage 205S for instance. In this case, the copy source VOL218P is included in at least one VOLs included in the first E/D storage 205P, and the copy destination VOL 218S is included in at least one VOLs included in the second E/D storage 205S. The business server group 202A accesses a VOL in the first E/D storage 205P via a storage network 221P. The business server group 202B accesses a VOL in the second E/D storage 205S via a storage network 221S.

The business server group 202A (202B) is provided with at least one business server 203A (203B). The business server 203A (203B) accesses a VOL by transmitting an I/O request (a write request or a read request) that specifies a VOL.

The copy source VOL 218P and the copy destination VOL 218S can be a real VOL or a virtual VOL.

The real VOL is a VOL based on a RAID (Redundant Array of Independent (or Inexpensive) Disks) group for instance. The RAID group is configured by a plurality of physical storage devices (such as a hard disk or a flash memory), and stores data at a RAID level that is defined for the RAID group. The copy source VOL 218P and the copy destination VOL 218S can be included in a plurality of VOLs based on one RAID group. However, it is preferable that the copy source VOL 218P and the copy destination VOL 218S are based on different RAID groups.

The virtual VOL can be a VOL of a type in which a real capacity is dynamically increased/decreased by dynamically assigning/releasing a storage region in a VOL that configures a pool for instance (such as a VOL according to Thin Provisioning technology), or can be a VOL that is formed based on a storage resource in an external storage system.

The E/D storage 205, 205P, 205S is provided with at least one E/D controllers (represented as E/D-CTL in the figures). The E/D controller is a controller that carries out an encryption and a decryption of data, and is a hardware circuit for instance. The E/D controller is provided with a memory for instance, and stores an encryption key/a decryption key (represented as EK/DK in the figures). In FIG. 1, an encryption key/a decryption key 207P corresponding to the copy source VOL 218P is configured to an E/D controller 204P. In addition, an encryption key/a decryption key 207S corresponding to the copy destination VOL 218S is configured to an E/D controller 204S in a VOL copy (a copy of data between VOLs). The E/D controller 204P is a controller that carries out an encryption/decryption of data that is input to or output from a copy source VOL. The E/D controller 204S is a controller that carries out an encryption/decryption of data that is input to or output from a copy destination VOL 218S.

A management server 201 is coupled to the E/D storages 205, 205P, and 205S via a management network (not shown). The management network is a second communication network, for instance a communication network in which a communication is carried out by an IP (Internet Protocol) (for instance a LAN (Local Area Network)). The management server 201 determines whether or not a security policy related to a copy destination VOL 218S is equal to a security policy related to a copy source VOL 218P. In the case in which a result of the determination is negative, the management server 201 carries out an encryption/decryption copy (hereafter referred to as an E/D copy). On the other hand, in the case in which a result of the determination is positive, the management server 201 carries out a non E/D copy, that is, a VOL copy in which an encryption and a decryption are not carried out.

More specifically, the management server 201 determines whether or not a data center provided with a copy destination VOL 218S is equal to a data center provided with a copy source VOL 218P (S201) in the case in which the management server 201 receives a copy instruction from a manager (S200) for instance. The VOLs of a copy destination and a copy source are specified by a copy instruction.

In the case in which a result of the determination of S201 is positive (S201: YES), the management server 201 determines whether or not a business server group that includes a business server that accesses a copy destination VOL 218S is equal to a business server group that includes a business server that accesses a copy source VOL 218P (S202).

In the case in which a result of the determination of S202 is positive (S202: YES), it is decided that a security policy related to a copy destination VOL 218S is equal to a security policy related to a copy source VOL 218P. The case in which S202 is YES is for the first case. In this case, the management server 201 decides to carry out a VOL copy in which an encryption and a decryption are not necessary (hereafter referred to as a non E/D copy) (S203). More specifically, the management server 201 configures an encryption key/a decryption key 207P that has been configured to the E/D controller 204P as an encryption key/a decryption key 207S related to a copy destination VOL 218S to the E/D controller 204S for instance. The management server 201 then indicates a non E/D copy from a copy source VOL 218P to a copy destination VOL 218S (a VOL copy and an undecryption/unencryption) to an E/D storage 205. By this, a non E/D copy is carried out. In other words, data that has been encrypted (the encrypted data) is read from a copy source VOL 218P, and the encrypted data is written to a copy destination VOL 218S without being decrypted and being re-encrypted.

On the other hand, in the case in which a result of the determination of S201 is negative (S201: NO) or in the case in which a result of the determination of S202 is negative (S202: NO), the management server 201 decides to carry out a VOL copy in which an encryption and a decryption are necessary (hereafter referred to as a non E/D copy) (S204). More specifically, the management server 201 configures a new encryption key/a decryption key 207S corresponding to a copy destination VOL 218S to the E/D controller 204S for instance. The management server 201 then indicates an E/D copy from a copy source VOL 218P to a copy destination VOL 218S (a VOL copy and an encryption/decryption) to an E/D storage 205 or to an E/D storage 205P and/or 205S. By this, an E/D copy is carried out. In other words, the encrypted data is read from a copy source VOL 218P, the encrypted data is decrypted by a decryption key 207P, and the decrypted data is encrypted by an encryption key 207S and written to a copy destination VOL 218S.

A mode for the present invention will be described below in detail with reference to the drawings. In the following descriptions, a storage resource is a main storage and/or an auxiliary storage for instance. The main storage is a volatile memory or a nonvolatile memory for instance. The auxiliary storage is a nonvolatile physical storage device (such as a hard disk or a flash memory) for instance. In the following descriptions, a security policy is referred to as SEC.

The business servers 203A and 203B are one of computers, and are provided with a storage resource, a processor that is coupled to a storage resource, and an I/F (an interface device) for carrying out a communication via a storage network. A processor reads a computer program such as an operating system (OS) and an application from a storage resource and executes the computer program. The processor issues an I/O request that specifies a VOL.

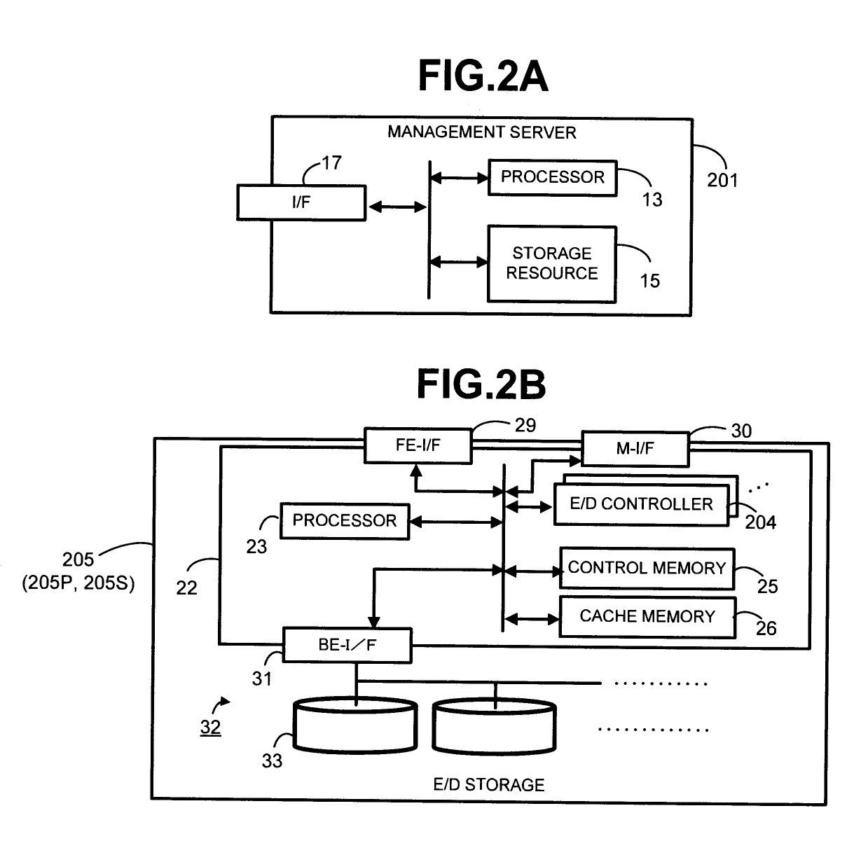

The management server 201 is also one of computers, and is provided with a storage resource 15, a processor 13 that is coupled to the storage resource 15, and an I/F 17 for carrying out a communication via a management network as shown in FIG. 2A.

The E/D storage 205 (similarly to 205P and 205S) is mainly composed of a storage part 32 and a controller 22.

The storage part 32 is provided with a plurality of RAID groups. Each of the RAID groups is provided with a plurality of physical storage devices (such as a hard disk or a flash memory) 33.

The controller 22 is a device that controls an operation of the E/D storage 205. The controller 22 is provided with the following elements for instance:

(1) a front-end interface device (FE-I/F) 29 that controls a communication via a storage network;
(2) a management interface device (M-I/F) 30 that controls a communication via a management network;
(3) a back-end interface device (BE-I/F) 31 that controls a communication with each physical storage device 33;
(4) a cache memory 26 that temporarily stores data that is transmitted or received between the physical storage device 33 and the business server 203A (203B);
(5) a memory (a control memory) 25 that stores data or a computer program for controlling the E/D storage 205;
(6) a processor 23 that reads a computer program from the control memory 25 and executes the computer program; and
(7) an E/D controller 204 that carries out an encryption of data by using a configured encryption key and that carries out a decryption of encrypted data by using a configured decryption key.

The E/D controller 204 is a hardware circuit for instance. The E/D controller 204 is provided with a memory (and/or another storage resource) for instance. An encryption key/a decryption key are configured to the memory. The E/D controller 204 is configured for every RAID group for instance. A RAID group that is a basis of a copy source VOL is different from a RAID group that is a basis of a copy destination VOL. In this case, an E/D controller that carries out an encryption/decryption of data that is input to or output from a copy source VOL is also different from an E/D controller that carries out an encryption/decryption of data that is input to or output from a copy destination VOL.

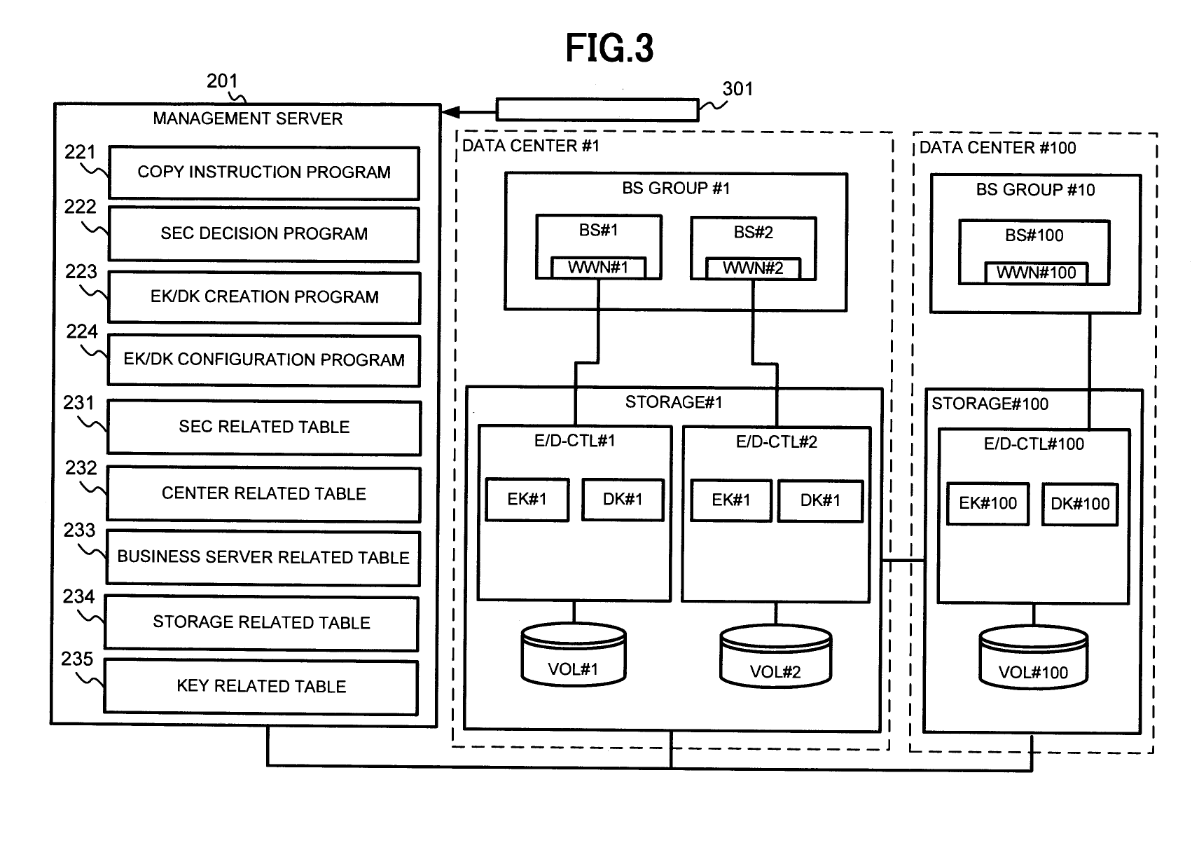

FIG. 3 shows an example of computer programs that are executed by a management server 201, data to be used in the server 21, and a data center. In the figure, a business server is referred to as BS, an E/D storage is referred to as STORAGE, an encryption key is referred to as EK, and a decryption key is referred to as DK.

There are data centers #1 and #100.

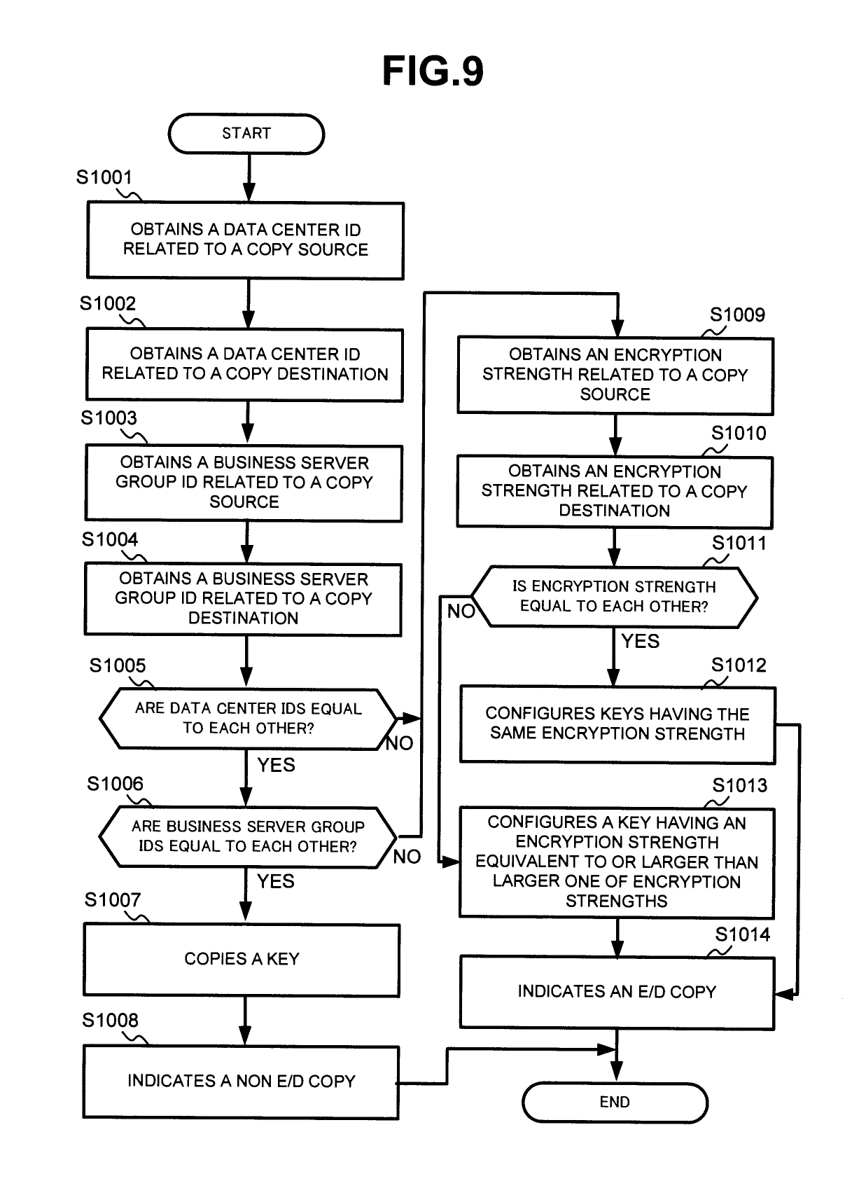

The data center #1 is provided with a business server group #1 and an E/D storage #1. The business server group #1 is composed of a business server #1 and a business server #2. The WWN (World Wide Name) #1 as an identifier is assigned to an I/F (for instance a port of a host bus adapter) of the business server #1, and the WWN #2 is assigned to an I/F of the business server #2. An E/D storage #1 is coupled to an E/D storage #100. The E/D storage #1 is provided with VOLs #1 and #2, an E/D controller #1 that carries out an encryption/decryption of data that is input to or output from the VOL #1, and an E/D controller #2 that carries out an encryption/decryption of data that is input to or output from the VOL #2. An encryption key #1 and a decryption key #1 are configured to the E/D controller #1. In the case in which the VOL #1 is a copy source VOL and the VOL #2 is a copy destination VOL in the example shown in FIG. 3, an encryption key #1/a decryption key #1 that are equal to an encryption key #1/a decryption key #1 configured to the E/D controller #1 are configured to the E/D controller #2 by the processing that will be described with reference to FIG. 9. For an encryption key/a decryption key, in the case in which an encryption system is a common key system, an encryption key/a decryption key are integrated to each other for instance. In the case in which an encryption system is a public key system, an encryption key/a decryption key are separate keys.

The data center #100 is provided with a business server group #10 and an E/D storage #100. The business server group #10 is composed of a business server #100. The WWN #100 is assigned to an I/F of the business server #10. The E/D storage #100 is provided with the VOL #100 and an E/D controller #100 that carries out an encryption/decryption of data that is input to or output from the VOL #100. In the case in which the VOL #1 is a copy source VOL and the VOL #100 is a copy destination VOL in the example shown in FIG. 3, an encryption key #100/a decryption key #100 that different from an encryption key #1/a decryption key #1 configured to the E/D controller #1 are configured to the E/D controller #100 by the processing that will be described with reference to FIG. 9.

As a computer program that is executed by the management server 201, the following programs can be mentioned for instance:

(1) a copy instruction program 221 that indicates a VOL copy to the E/D storage;
(2) a SEC decision program 222 that compares a SEC for a copy source VOL and a SEC for a copy destination VOL;
(3) an encryption key/decryption key creation program 223 that creates an encryption key/a decryption key; and
(4) an encryption key/decryption key configuration program 224 that configures an encryption key/a decryption key.
The above programs are loaded from a memory to the processor 13 and are executed. In the case in which a computer program is a subject in the following descriptions, a processing is carried out by the processor 13 that executes the computer program in a practical sense. The above programs are installed from a program source 301. The program source 301 is a server or a storage media (such as a CD-ROM) for instance. In the case in which the program source 301 is a server, the source 301 is provided with a storage resource (such as a memory) that stores a program to be distributed or the like, an I/F, and a processor that is coupled to the storage resource and that distributes a program via the I/F.

As the information that is referred to by the management server 201, the following table groups can be mentioned for instance:

(1) a SEC related table group 231 that indicates the information related to SEC;
(2) a center related table group 232 that indicates the information related to a data center;
(3) a business server related table group 233 that indicates the information related to a business server;
(4) a storage related table group 234 that indicates the information related to an E/D storage; and
(5) a key related table group 235 that indicates the information related to an encryption key/a decryption key.
The above table groups are stored into the storage resource 15. Moreover, the information can be not only information of a table group but also information of other kinds.

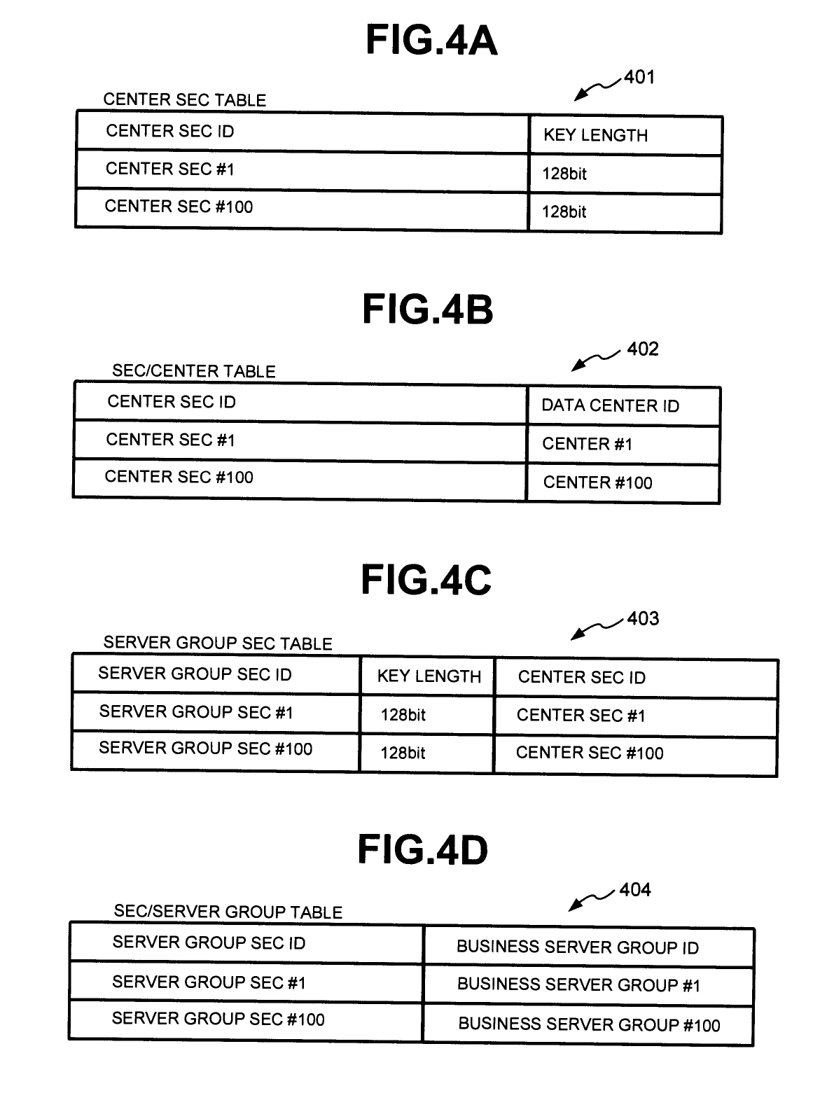

The table groups 231, 232, 233, 234, and 235 will be described in details with reference to FIGS. 4A to 7D in the following. The tables shown in FIGS. 4A to 7D are corresponded to the example shown in FIG. 3 (a configuration example of a data center, a business server group, and an E/D storage).

The tables shown in FIGS. 4A to 4D are tables that are included in the SEC related table group 231.

FIG. 4A shows a center SEC table 401. The table 401 indicates a definition of every center SEC. More specifically, for every center SEC, the table 401 lists an ID of a center SEC and the information that indicates a key length decided for the center SEC for instance. A center SEC is a SEC for a data center.

FIG. 4B shows a SEC/center table 402. The table 402 indicates a center SEC and a data center to which the center SEC is applied. More specifically, for every center SEC, the table 402 lists an ID of a center SEC and an ID of a data center to which the center SEC is applied for instance.

FIG. 4C shows a server group SEC table 403. The table 403 indicates a definition of every server group SEC. More specifically, for every server group SEC, the table 403 lists an ID of a server group SEC and the information that indicates a key length decided for the server group SEC for instance. In addition, the table 403 lists an ID of a center SEC that is applied to the server group SEC. A server group SEC is a SEC for a business server group. Moreover, a key length for the server group SEC is equivalent to or larger than a key length for a center SEC that is applied to the server group SEC. In other words, a lower limit of a key length for the server group SEC is a key length for a center SEC that is applied to the server group SEC.

FIG. 4D shows a SEC/server group table 404. The table 404 indicates a server group SEC and a business server group to which the server group SEC is applied. More specifically, for every server group SEC, the table 404 lists an ID of a server group SEC and an ID of a business server group to which the server group SEC is applied for instance.

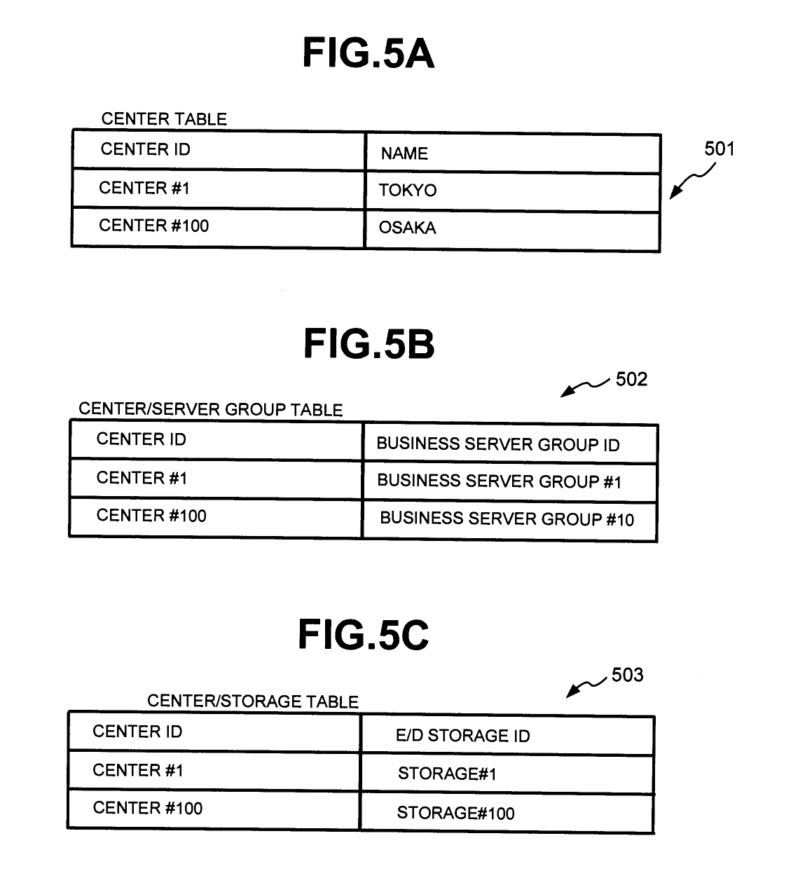

The tables shown in FIGS. 5A to 5C are tables that are included in the center related table group 232.

FIG. 5A shows a center table 501. The table 501 indicates a name (for instance a place) of a data center. More specifically, for every data center, the table 501 lists an ID of a data center and a name of the data center for instance.

FIG. 5B shows a center/server group table 502. The table 502 indicates a data center and a business server group that is included in the data center. More specifically, for every data center, the table 502 lists an ID of a data center and an ID of a business server group that is included in the data center for instance.

FIG. 5C shows a center/storage table 503. The table 503 indicates a data center and an E/D storage that is included in the data center. More specifically, for every data center, the table 503 lists an ID of a data center and an ID of an E/D storage that is included in the data center for instance.

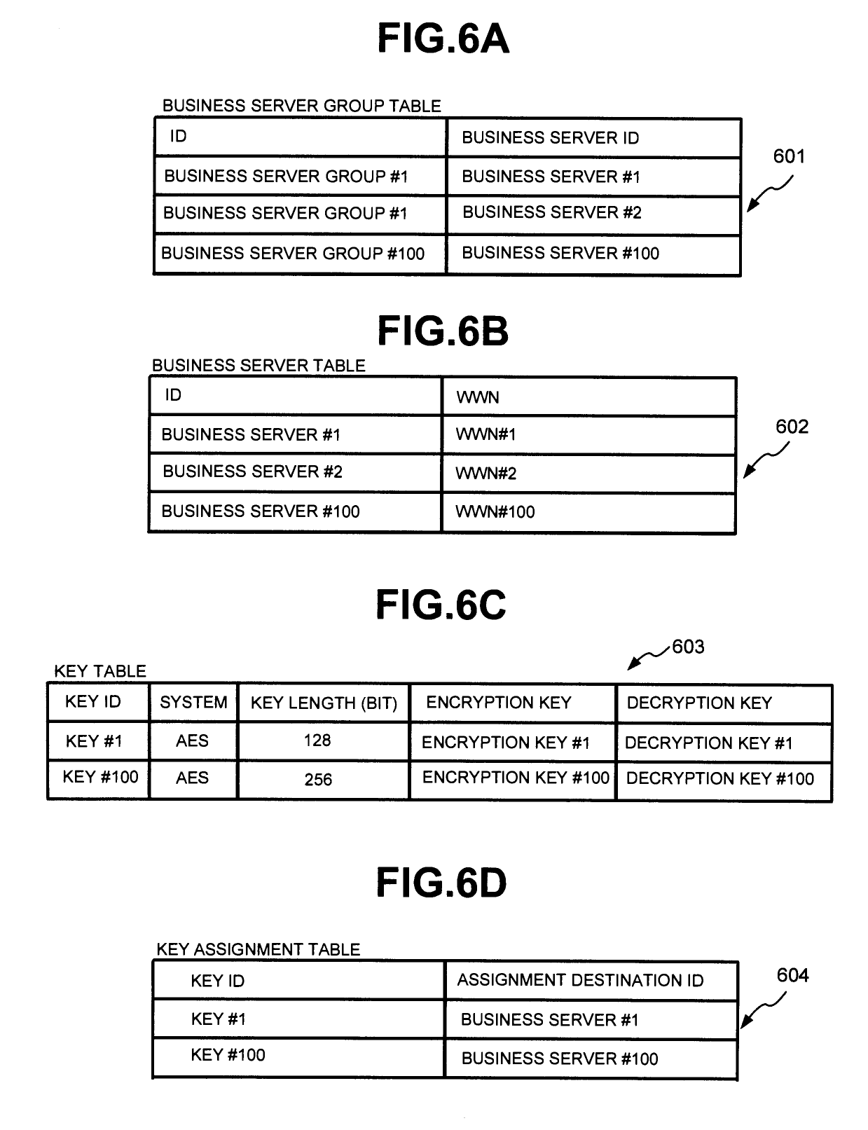

The tables shown in FIGS. 6A and 6B are tables that are included in the business server related table group 233.

FIG. 6A shows a business server group table 601. The table 601 indicates a business server group and a server that is included in the business server group. More specifically, for every business server group, the table 601 lists an ID of a business server group and an ID of a server that is included in the business server group for instance.

FIG. 6B shows a business server table 602. The table 602 indicates a business server and a WWN that is assigned to an I/F (port) included in the business server. More specifically, for every business server, the table 602 lists an ID of a business server and a WWN that is assigned to an I/F included in the business server for instance.

The tables shown in FIGS. 6C and 6D are tables that are included in the key related table group 235.

FIG. 6C shows a key table 603. The table 603 indicates an attribute of an encryption key/a decryption key and an attribute of an encryption/decryption in which the keys are used. More specifically, for every encryption key/decryption key, the table 603 lists an ID of an encryption key/a decryption key, the information that indicates a system of an encryption/decryption in which the encryption key/decryption key are used, the information that indicates a key length of the encryption key/decryption key, an encryption key itself, and a decryption key itself for instance.

FIG. 6D shows a key assignment table 604. The table 604 indicates an encryption key/a decryption key and a business server group to which the encryption key/decryption key are assigned. More specifically, for every encryption key/decryption key, the table 604 lists an ID of an encryption key/a decryption key and an ID of a business server group to which the encryption key/decryption key are assigned for instance.

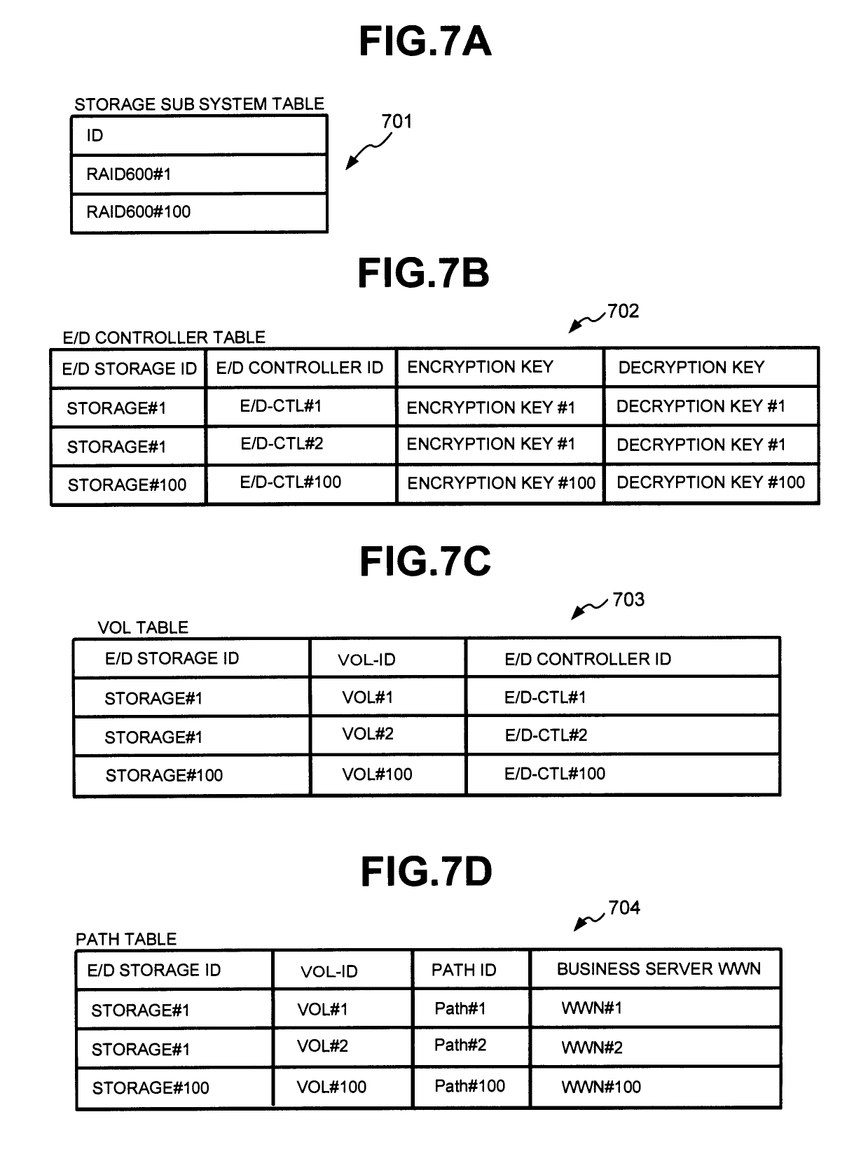

The tables shown in FIGS. 7A and 7D are tables that are included in the storage related table group 234.

FIG. 7A shows a storage table 701. The table 701 lists an ID of an E/D storage for instance.

FIG. 7B shows an E/D controller table 702. The table 702 indicates an E/D storage, an E/D controller that is included in the E/D storage, and an encryption key/a decryption key that is included in the E/D controller. More specifically, for every E/D controller, the table 702 lists an ID of an E/D controller, an ID of an E/D storage that includes the E/D controller, and an encryption key/a decryption key that are included in the E/D controller for instance. As substitute for an encryption key/a decryption key, the ID thereof can be listed.

FIG. 7C shows a VOL table 703. The table 703 indicates a VOL, an E/D storage that includes the VOL, and an E/D controller that carries out an encryption/decryption. More specifically, for every VOL, the table 703 lists an ID of a VOL, an ID of an E/D storage that includes the VOL, and an ID of an E/D controller that carries out an encryption/decryption of data that is input to or output from the VOL for instance.

FIG. 7D shows a path table 704. The table 704 indicates a configuration of a path from a business server to a VOL. More specifically, for every path, the table 704 lists an ID of a path, a WWN of an I/F that is one end of the path (an I/F that is included in the business server), an ID of a VOL that is the other end of the path, and an ID of an E/D storage that includes the VOL for instance.

The details of the table groups 231, 232, 233, 234, and 235 shown in FIG. 3 have been described above. In the mode for the present invention, there is a SEC for every data center and every business server. However, a SEC can also be defined in different units.

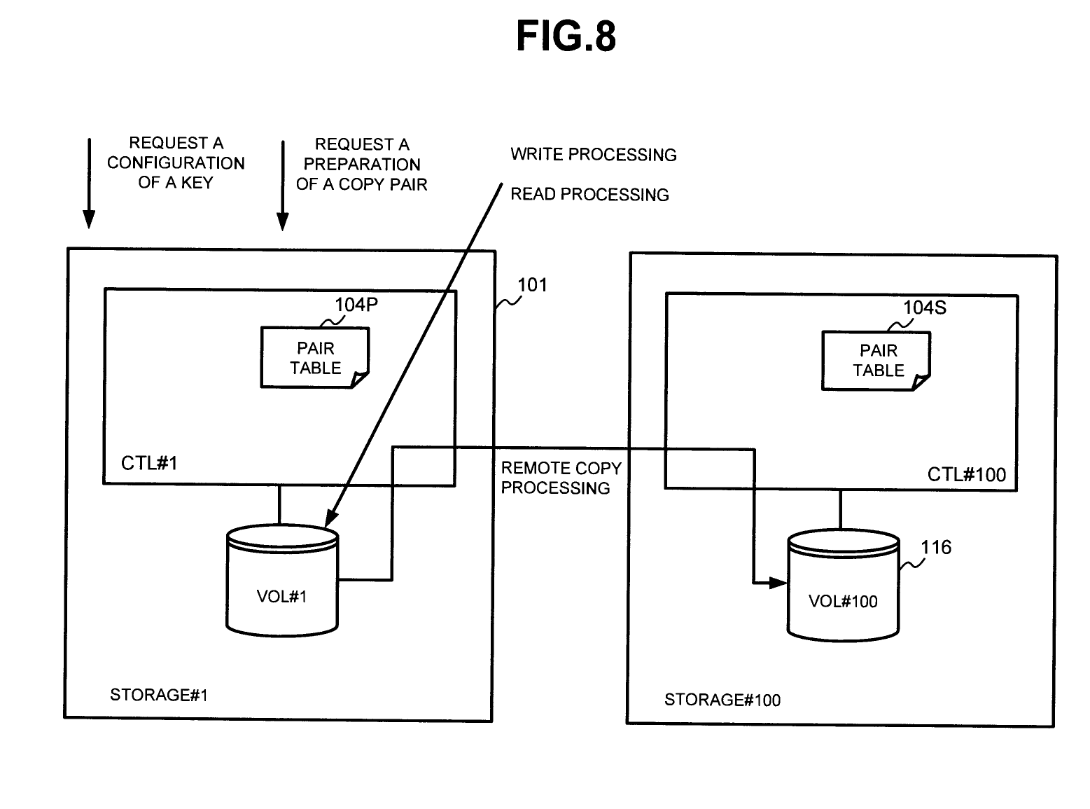

FIG. 8 illustrates a processing that is carried out by a controller (CTL) #1 included in an E/D storage #1 of a copy source and a processing that is carried out by a controller (CTL) #10 included in an E/D storage #100 of a copy destination. This figure is in the case in which a VOL copy is a remote copy.

The CTL #1 (#100) is provided with a pair table 104P (104S). The pair table 104P (104S) is stored into a control memory 25 for instance. The pair table 104P (104S) is the information that indicates the VOLs that are a pair. For instance, the pair table 104P (104S) is provided with an ID of an E/D storage of a copy source, an ID of a VOL of a copy source, an ID of an E/D storage of a copy destination, an ID of a VOL of a copy destination, and a flag that indicates whether or not an encryption/decryption is inhibited in a VOL copy (hereafter referred to as an E/D inhibit flag) for every VOL pair. The E/D inhibit flag is turned ON in the case in which an encryption/decryption is inhibited (an encryption/decryption is not required). The E/D inhibit flag is turned OFF in the case in which an encryption/decryption is not inhibited (an encryption/decryption is required). Not only a table but also information of other types can be adopted. Moreover, an ID of an E/D storage can also be omitted.

As a processing that is carried out by CTLs #1 and #100, there can be mentioned for instance a creation of a VOL pair, a configuration of an encryption key/a decryption key, a write processing, a read processing, and a remote copy processing.

A creation of a VOL pair will be described in the following. The CTL #1 (#100) receives a pair creation request of a VOL copy accompanied with a specification related to an encryption from the management server 201 (a copy instruction program 221). The CTL #1 then configures the information related to a VOL pair that is specified by the request to a pair table 104P. In addition, the CTL #1 turns ON the E/D inhibit flag for the VOL pair in the case in which a pair creation request includes the information that indicates that an encryption/decryption is not required. Moreover, the CTL #1 makes CLT #100 to specify the information equal to information that has been specified to the pair table 104P (information for a VOL pair that conforms to a pair creation request) to the pair table 104S.

A configuration of an encryption key/a decryption key will be described in the following. The CTL #1 receives a key configuration request from the management server 201 (an encryption key/a decryption key configuration program 224). The request includes an encryption key/a decryption key, a volume ID for the encryption key/decryption key, and an ID of an E/D controller. The CTL #1 responds to the request and stores an encryption key/a decryption key and a volume ID in the request into a memory of CTL #1. More specifically, the CTL #1 stores a volume ID and an E/D controller ID in the key configuration request into a VOL table 703, and stores an encryption key/a decryption key and an E/D controller ID in the request into an E/D controller 702.

A write processing will be described in the following.

(1) The CTL #1 receives a write request that specifies VOL #1 and an address in a VOL (for instance LBA (Logical Block Address)) and a write data.
(2) The CTL #1 specifies a physical storage device in which write data is to be stored from the specified VOL #1 and an address in a VOL.
(3) The CTL #1 specifies an encryption key for the specified VOL #1 by referring to the tables 703 and 702.
(4) The CTL #1 carries out an encryption of data by the specified encryption key and then stores the encrypted data into the specified physical storage device.

A read processing will be described in the following.

(1) The CTL #1 receives a read request that specifies VOL #1 and an address in a VOL.
(2) The CTL #1 specifies a physical storage device that stores data that is to be transmitted to a business host of a transmit source of a read request from the specified VOL #1 and an address in a VOL.
(3) The CTL #1 specifies a decryption key for the specified VOL #1 by referring to the tables 703 and 702.
(4) The CTL #1 reads data (encryption data) from the specified physical storage device, carries out a decryption of the data by the specified decryption key, and then transmits the decrypted data to a business host of a transmit source of a read request.

A remote copy processing includes an initializing processing, a processing of a duplication state, and a copy restart processing for instance.

An initializing processing will be described in the following. In the following descriptions, the E/D inhibit flag that is corresponded to a pair of a copy source VOL #1 and a copy destination VOL #100 is referred to as a target flag.

(A1) The CTL #1 receives a pair initializing indication from the management server 201 (a copy instruction program 221). The pair initializing indication includes an ID of an E/D storage of a copy source, an ID of a VOL of a copy source, an ID of an E/D storage of a copy destination, an ID of a VOL of a copy destination, and an E/D inhibit flag (ON or OFF) in a copy.
(A2) The CTL #1 stores the information in the pair initializing indication into the pair table 104P (104S).
(A3) The CTL #1 starts an initial copy. More specifically, the following processing is carried out in the initial copy.
(A3-1) The CTL #1 reads encryption data in a copy source VOL #1;
(A3-2) In the case in which the target flag in the pair table 104P is OFF, the CTL #1 carries out a decryption of the read encryption data by an encryption key corresponding to a copy source VOL, and transmits the decrypted data to the E/D storage #100 (CTL #100) of a copy destination (in the case in which the target flag is ON, the encryption data is not decrypted and is transmitted to the CTL #100); and
(A3-3) In the case in which the target flag in the pair table 104S is OFF, the CTL #100 carries out an encryption of the received data by a decryption key corresponding to a copy destination VOL, and stores the encrypted data into a copy destination VOL (in the case in which the target flag is ON, the received data is not encrypted and is stored into a copy destination VOL). The processes (A3-1), (A3-2), and (A3-3) are carried out for all addresses of the specified VOL (or the specified region).
(A4) The CTL #1 carries out a transition of a state of a VOL pair to a duplication state at the point when the initial copy is completed.

A processing of a duplication state will be described in the following.

(B1) In the case in which the CTL #1 receives a write request to a copy source VOL #1, the CTL #1 transmits the write data that has been received along with the above write processing to the CTL #100. Since an encryption of write data is carried out on a cache memory 26, in the case in which the target flag in the pair table 104P is ON, the encrypted write date is transmitted without change. In the case in which the target flag in the pair table 104P is OFF, the encryption date is decrypted and then transmitted the CTL #100.
(B2) The CTL #100 receives a write data. In the case in which the target flag in the pair table 104S is ON, the CTL #100 stores the encryption write date into a copy destination VOL #100. On the other hand, in the case in which the target flag in the pair table 104S is OFF, the CTL #100 carries out a decryption of the write date by an encryption key that is corresponded to the copy destination VOL #100, and stores the encryption date into a copy destination VOL #100.

In a copy restart processing, after the CTL #1 receives a copy restart request, the CTL #1 carries out (A3) and subsequent processing of the initializing processing for a region in which a difference occurs.

The remote copy processing have been described above. In the case in which a copy destination VOL is in an E/D storage that includes a copy source VOL, a local copy processing is carried out. The local copy processing is substantially equal to the remote copy processing. In the local copy processing, a processing that is carried out by the CTL #100 in the remote copy processing is carried out by the CTL #1.

In the case in which the management server 201 receives a copy instruction from a manager, the management server 201 carries out a copy control processing as shown in FIG. 9. In a copy instruction, an ID of a copy source VOL and an ID of a copy destination VOL are specified for instance.

FIG. 9 shows a flow of a copy control processing.

S1001: A SEC decision program 222 obtains a data center ID related to a copy source. More specifically, a SEC decision program 222 obtains a storage ID that is corresponded to an ID of a copy source VOL that is specified by a copy instruction from a VOL table 703 (see FIG. 7C) for instance. The SEC decision program 222 obtains a data center ID that is corresponded to the storage ID from a center/storage table 503 (see FIG. 5C).

S1002: A SEC decision program 222 obtains a data center ID related to a copy destination. More specifically, a SEC decision program 222 obtains an ID of a data center that includes an E/D storage provided with a copy source VOL by carrying out a processing equivalent to S1001 using an ID of a copy destination VOL as a key for instance. The ID copy destination VOL is a VOL that is specified based on a copy instruction.

S1003: A SEC decision program 222 obtains a business server group ID related to a copy source. More specifically, a SEC decision program 222 obtains a WWN that is corresponded to an ID of a copy source VOL that is specified by a copy instruction from a path table 704 (see FIG. 7D) for instance. The SEC decision program 222 obtains a business server ID that is corresponded to the WWN from a business server table 602 (see FIG. 6B). The SEC decision program 222 obtains a business server group ID that is corresponded to the business server ID from a business server group table 601 (see FIG. 6A).

S1004: A SEC decision program 222 obtains a business server group ID related to a copy destination. More specifically, a SEC decision program 222 obtains an ID of a business server group that includes a business server that accesses a copy destination VOL by carrying out a processing equivalent to S1003 using an ID of a copy destination VOL that is specified by a copy instruction as a key for instance.

S1005: A SEC decision program 222 compares a data center ID that has been obtained in S1001 and a data center ID that has been obtained in S1002. As a result of the comparison, S1006 is carried out in the case in which the data center IDs are equal to each other, and S1011 is carried out in the case in which the data center IDs are different from each other.

S1006: A SEC decision program 222 compares a business server group ID that has been obtained in S1003 and a business server group ID that has been obtained in S1004. As a result of the comparison, S1007 is carried out in the case in which the business server group IDs are equal to each other, and S1009 is carried out in the case in which the business server group IDs are different from each other. Before S1006, it is determined whether or not a business server group ID has been obtained in S1004. A result of the determination is negative, an error processing can also be carried out.

For instance, S1007 and S1008 are carried out in the case in which a copy source VOL is VOL #1 and a copy destination VOL is VOL #2 in FIG. 3.

S1007: An E/D configuration program 224 copies an encryption key/a decryption key that are configured to an E/D controller #1 that is corresponded to a copy source VOL #1 to an E/D controller #2 that is corresponded to a copy destination VOL #2. More specifically, an E/D configuration program 224 obtains an encryption key/a decryption key ID #1 that is corresponded to a business server group ID #1 that has been obtained in S1003 from a key assignment table 604 (see FIG. 6D) for instance. The E/D configuration program 224 obtains an encryption key #1/a decryption key #1 that are corresponded to the encryption key/decryption key ID #1 from a key table 603 (see FIG. 6C). The E/D configuration program 224 obtains an E/D controller ID #2 that is corresponded to the ID #2 of a copy destination VOL from a VOL table 703 (see FIG. 7C). The E/D configuration program 224 configures an encryption key #1/a decryption key #1 that has been obtained from the key table 603 to the E/D controller ID #2 that is corresponded to the E/D controller ID #2.

S1008: A copy instruction program 221 indicates a non E/D copy to the E/D storage #1 provided with a copy source VOL #1 and a copy destination VOL #2. More specifically, a copy instruction program 221 obtains a storage ID #1 that is corresponded to an ID #1 of a copy source VOL and an ID #2 of a copy destination VOL from a VOL table 703 (see FIG. 7C) for instance. The copy instruction program 221 transmits a copy instruction that includes an E/D inhibit flag ON in addition to an ID #1 of a copy source VOL and an ID #2 of a copy destination VOL to the E/D storage #1 that is corresponded to an E/D storage ID #1. By this, in the E/D storage #1, the E/D inhibit flag ON is configured to the pair table 104P, and a local copy is carried out from a copy source VOL #1 to a copy destination VOL #2 without carrying out an encryption or a decryption.

S1009: An E/D configuration program 224 obtains an encryption strength related to a copy source. More specifically, an E/D configuration program 224 obtains an encryption key/decryption key ID that is corresponded to a business server group ID that has been obtained in S1003 from the key assignment table 604 for instance. The E/D configuration program 224 obtains an encryption strength (a key length) that is corresponded to the encryption key/decryption key ID from the key table 603.

S1010: An E/D configuration program 224 obtains an encryption strength related to a copy destination. More specifically, an E/D configuration program 224 obtains an SEC ID that is corresponded to a business server group ID that has been obtained in S1004 from the SEC/server group table 404 (see FIG. 4D) for instance. The E/D configuration program 224 obtains an encryption strength (a key length) that is corresponded to the SEC ID from the server group/SEC table 403 (see FIG. 4C).

S1011: An E/D configuration program 224 compares an encryption strength that has been obtained in S1009 and an encryption strength that has been obtained in S1010. As a result of the comparison, S1012 is carried out in the case in which the encryption strength is equal to each other, and S1013 is carried out in the case in which the an encryption strength is different from each other.

S1012: An encryption key/a decryption key having an encryption strength equivalent to that obtained in S1010 are created, and the encryption key/decryption key are configured to an E/D controller that is corresponded to a copy destination VOL (hereafter referred to as a copy destination E/D controller). More specifically, an E/D creation program 223 creates a new encryption key/a decryption key having an encryption strength equivalent to that obtained in a step S1009 for instance. The E/D creation program 223 stores an ID of the encryption key/decryption key into a key table 603 and a key assignment table 604, and stores the encryption key/decryption key into a key table 603 and an E/D controller table 702. The E/D configuration program 224 obtains an E/D controller ID that is corresponded to a copy destination VOL from a VOL table 703. The E/D configuration program 224 configures the encryption key/decryption key that have been created as described above to a copy destination E/D controller that is corresponded to the E/D controller ID.

S1013: An encryption key/a decryption key having an encryption strength equivalent to or larger than larger one of an encryption strength obtained in S1009 and an encryption strength obtained in S1010 are created, and the encryption key/decryption key are configured to a copy destination E/D controller. More specifically, an E/D creation program 223 creates an encryption key/a decryption key having an encryption strength equivalent to or larger than larger one of an encryption strength obtained in S1009 and an encryption strength obtained in S1010 for instance. The E/D creation program 223 stores an ID of the encryption key/decryption key into a key table 603 and a key assignment table 604, and stores the encryption key/decryption key into a key table 603 and an E/D controller table 702. The E/D configuration program 224 obtains an E/D controller ID that is corresponded to a copy destination VOL from a VOL table 703. The E/D configuration program 224 configures the encryption key/decryption key that have been created as described above to an E/D controller that is corresponded to the E/D controller ID.

S1014: A copy instruction program 221 indicates an E/D copy to an E/D storage provided with a copy source VOL and an E/D storage provided with a copy destination VOL. In the case in which the E/D storages are separate from each other, an E/D copy is indicated to separate E/D storages. In the case in which the E/D storages are equal to each other, an E/D copy is indicated to the same E/D storage. In the case in which the former is taken as an example, in FIG. 3, a copy source VOL is a VOL #1, and a copy destination VOL is a VOL #100. In this case, a copy instruction program 221 obtains a storage ID #1 that is corresponded to an ID #1 of a copy source VOL and a storage ID #100 that is corresponded to an ID #100 of a copy destination VOL from a VOL table 703 (see FIG. 7C) for instance. The copy instruction program 221 transmits a copy instruction that includes an E/D inhibit flag OFF in addition to an ID #1 of a copy source VOL and an ID #100 of a copy destination VOL to the E/D storage #1 that is corresponded to an E/D storage ID #1 and the E/D storage #100 that is corresponded to an E/D storage ID #100. By this, the E/D inhibit flag OFF is configured to the pair tables 104P and 104S for a pair of a VOL #1 and a VOL #100, respectively, and a remote copy is carried out from a copy source VOL #1 to a copy destination VOL #100. In this case, an encryption data that has been read from a copy source VOL #1 is decrypted by an E/D controller #1 using a decryption key #1. The data that has been decrypted is transmitted to the CTL #100. An encryption of the data is carried out by an E/D controller #100 using an encryption key #100. The data that has been encrypted is stored into a copy destination VOL #100.

The copy control processing has been described above.

In S1012 and S1013, a new key can be created without using an existing key, or a new key can be created by using an existing key. For instance, an E/D creation program 223 can also create an encryption key/a decryption key that are configured to a copy destination E/D controller by using an encryption key/a decryption key that have been configured for an E/D storage of a copy destination.

Moreover, in S1012, as substitute for creating an encryption key/a decryption key having the equivalent encryption strength, an encryption key/a decryption key for a copy source VOL can also be copied to a copy destination E/D controller.

While the preferred embodiments in accordance with the present invention have been described above, it goes without saying that the present invention is not restricted to the embodiments, and various changes, modifications, and functional additions can be thus made without departing from the scope of the present invention.

For instance, for whether or not SECs are equivalent to each other, as substitute for or in addition to the followings (A) and/or (B), the followings (C) and/or (D) can be also considered:

(A) whether or not data centers are equivalent to each other;
(B) whether or not business server groups are equivalent to each other;
(C) whether or not encryption strengths are equivalent to each other;
(D) whether or not an encryption key/a decryption key are equivalent to each other.

Moreover, an encryption strength can also be defined by other elements such as an encryption system as substitute for or in addition to a key length. An initial vector can also be included in a concept of an encryption strength. In other words, in the case in which it is determined whether or not encryption strengths are equivalent to each other, an initial vector can be considered.

What is claimed is:

1. A computer that is coupled to at least one storage system, wherein:
the storage system is provided with an encryption key/a decryption key and a logical volume, encrypts data that is stored into the logical volume by the encryption key, and decrypts the encryption data that has been read from the logical volume by the decryption key,
a copy source volume that is a logical volume of a copy source is in a storage system of the at least one storage system,
a copy destination volume that is a logical volume of a copy destination is in the storage system provided with the copy source volume or another storage system,
a copy destination storage that is the storage system provided with the copy destination volume is a storage system equivalent to or different from a copy source storage that is the storage system provided with the copy source volume,
the decryption key is the encryption key that is also used as a key for a decryption or a key separate from the encryption key,
the computer comprising:
a storage resource; and
a processor that is coupled to the storage resource,
the storage resource stores the control information that includes information associated with a security policy related to the copy source volume and the copy destination volume, and
the processor carries out the following processing (A) to (C):
(A) determining whether or not a security policy related to a copy destination volume is equal to a security policy related to a copy source volume based on the control information;
(B) configuring an encryption key/a decryption key related to the copy source volume as an encryption key/a decryption key related to the copy destination volume to the copy destination storage in the case in which a result of the determination is positive; and
(C) indicating a copy of data from the copy source volume to the copy destination volume and an unencryption and an undecryption to the copy source storage and/or the copy destination storage.

2. The computer according to claim 1, comprising at least one computer system,
wherein the computer system comprises at least one storage system and at least one host group that is coupled to the storage system,
wherein the host group comprises at least one host,
wherein the control information include:
system configuration information that indicates a computer system and a host group and a storage system in the computer system;
host group configuration information that indicates a host group and a host included in the host group;
path information that indicates a host and a logical volume that is accessed from the host; and
security related information that indicates an encryption strength related to a host group,
wherein the encryption strength is strength of an encryption/a decryption, wherein the processor carries out the following processing (A-1) and (A-2) in the above processing (A):
(A-1) carrying out a first determination of whether or not the computer system provided with the copy destination storage is equal to the computer system provided with the copy source storage based on the system configuration information; and
(A-2) carrying out a second determination of whether or not the copy destination host group that is a host group provided with a host that accesses the copy destination volume is equal to the copy source host group that is a host group provided with a host that accesses the copy source volume based on the host group configuration information and the path information in the case in which a result of the first determination is positive,
wherein the processor carries out the above processing (B) and (C) in the case in which a result of the second determination is positive,
wherein the processor carries out a third determination of whether or not the encryption strength related to the copy source host group is equal to the encryption strength related to the copy destination host group based on the security related information in the case in which a result of the first determination or the second determination is negative, and
wherein the processor carries out the following processing (D) and (E) in the case in which a result of the third determination is negative:
(D) creating an encryption key/a decryption key having an encryption strength equivalent to or larger than larger one of an encryption strength related to the copy source host group and an encryption strength related to the copy destination host group, and configuring the encryption key/decryption key to the copy destination storage; and
(E) indicating a copy of data from the copy source volume to the copy destination volume and an encryption and a decryption to the copy source storage and/or the copy destination storage.

3. The computer according to claim 2, wherein:
the processor carries out the above processing (B) and (C) in the case in which a result of the third determination is positive.

4. The computer according to claim 2, wherein:
the processor creates an encryption key/a decryption key having an encryption strength equivalent to or larger than the larger one by using an existing encryption key/decryption key in the above processing (D).

5. The computer according to claim 2, wherein:
the processor carries out the following processing (F) and (G) in the case in which a result of the third determination is positive.
(F) creating an encryption key/a decryption key having an encryption strength equivalent to or larger than an encryption strength related to the copy destination host group, and configuring the encryption key/decryption key to the copy destination storage; and
(G) indicating a read and a decryption of data that has been stored into the copy source volume to the copy source storage, and indicating a write and an encryption of the data that has been read to the copy destination storage.

6. The computer according to claim 5, wherein:
the processor creates an encryption key/a decryption key having an encryption strength equivalent to or larger than an encryption strength related to the copy destination host group by using an existing encryption key/decryption key in the above processing (F).

7. The computer according to claim 1, wherein:
the processor carries out the following processing (A-1) and (A-2) in the above processing (A):
(A-1) carrying out a first determination of whether or not the computer system provided with the copy destination storage is equal to the computer system provided with the copy source storage; and
(A-2) carrying out a second determination of whether or not the copy destination host group that is a host group provided with a host that accesses the copy destination volume is equal to the copy source host group that is a host group provided with a host that accesses the copy source volume in the case in which a result of the first determination is positive, and
a result of the determination in the above processing (A) is positive in the case in which a result of the second determination is positive.

8. The computer according to claim 1, wherein:
the processor carries out the following processing (A-1) and (A-3) in the above processing (A):
(A-1) carrying out a first determination of whether or not the computer system provided with the copy destination storage is equal to the computer system provided with the copy source storage based on the system configuration information; and
(A-3) carrying out a second determination of whether or not an encryption strength related to the copy destination host group is equal to an encryption strength related to the copy source host group in the case in which a result of the first determination is negative,
the encryption strength is strength of an encryption/a decryption,
the copy destination host group is a host group provided with a host that accesses the copy destination volume,
the copy source host group is a host group provided with a host that accesses the copy source volume, and
a result of the determination in the above processing (A) is positive in the case in which a result of the third determination is positive.

9. The computer according to claim 1, wherein:
the processor carries out a third determination of whether or not an encryption strength related to the copy destination host group is equal to an encryption strength related to the copy source host group in the case in which a result of the determination in the above processing (A) is negative,
the encryption strength is strength of an encryption/a decryption,
the copy destination host group is a host group provided with a host that accesses the copy destination volume,
the copy source host group is a host group provided with a host that accesses the copy source volume, and
the processor carries out the following processing (D) and (E) in the case in which a result of the third determination is negative.
(D) creating an encryption key/a decryption key conforming to a larger encryption strength of an encryption strength related to the copy source host group and an encryption strength related to the copy destination host group, and configuring the encryption key/decryption key to the copy destination storage; and
(E) indicating a copy of data from the copy source volume to the copy destination volume and an unencryption and an undecryption to the copy source storage and/or the copy destination storage.

10. The computer according to claim 9, wherein:
the processor creates an encryption key/a decryption key having an encryption strength equivalent to or larger than an encryption strength related to the copy destination host group by using an existing encryption key/decryption key in the above processing (D).

11. The computer according to claim 1, wherein:
the processor carries out a third determination of whether or not an encryption strength related to the copy destination host group is equal to an encryption strength related to the copy source host group in the case in which a result of the determination in the above processing (A) is negative,
the encryption strength is strength of an encryption/a decryption,
the copy destination host group is a host group provided with a host that accesses the copy destination volume,
the copy source host group is a host group provided with a host that accesses the copy source volume, and
the processor carries out the following processing (F) and (G) in the case in which a result of the third determination is negative.
(D) creating an encryption key/a decryption key conforming to an encryption strength related to the copy destination host group, and configuring the encryption key/decryption key to the copy destination storage; and
(E) indicating a copy of data from the copy source volume to the copy destination volume and an unencryption and an undecryption to the copy source storage and/or the copy destination storage.

12. The computer according to claim 11, wherein:
the processor creates an encryption key/a decryption key having an encryption strength equivalent to or larger than an encryption strength related to the copy destination host group by using an existing encryption key/decryption key in the above processing (F).

13. The computer according to claim 7, wherein:
an encryption strength related to a host group is an encryption strength equivalent to or larger than an encryption strength related to a computer system provided with the host group.

14. A computer system, comprising:
at least one storage system; and
a computer that is coupled to the at least one storage system, wherein:
the storage system is provided with an encryption key/a decryption key and a logical volume, encrypts data that is stored into the logical volume by the encryption key, and decrypts the encryption data that has been read from the logical volume by the decryption key,
a copy source volume that is a logical volume of a copy source is in a storage system of the at least one storage system,
a copy destination volume that is a logical volume of a copy destination is in the storage system provided with the copy source volume or another storage system,
a copy destination storage that is the storage system provided with the copy destination volume is a storage system equivalent to or different from a copy source storage that is the storage system provided with the copy source volume,
the decryption key is the encryption key that is also used as a key for a decryption or a key separate from the encryption key,
the computer comprising:
a storage resource; and
a processor that is coupled to the storage resource,
the storage resource stores the control information that includes information associated with a security policy related to the copy source volume and the copy destination volume,
the processor carries out the following processing (A) to (C):
(A) determining whether or not a security policy related to a copy destination volume is equal to a security policy related to a copy source volume based on the control information;
(B) configuring an encryption key/a decryption key related to the copy source volume as an encryption key/a decryption key related to the copy destination volume to the copy destination storage in the case in which a result of the determination is positive; and
(C) indicating a copy of data from the copy source volume to the copy destination volume and an unencryption and an undecryption to the copy source storage and/or the copy destination storage, and
the copy source storage reads data that has been stored into the copy source volume, and does not decrypt the data, and
the copy source storage does not encrypt the data that has been read, and writes the data to the copy destination volume.

15. A recording medium storing a computer program that is executed by a computer, wherein:
the computer program is executed by a computer that is coupled to at least one storage system
the storage system is provided with an encryption key/a decryption key and a logical volume, encrypts data that is stored into the logical volume by the encryption key, and decrypts the encryption data that has been read from the logical volume by the decryption key,
a copy source volume that is a logical volume of a copy source is in a storage system of the at least one storage system,
a copy destination volume that is a logical volume of a copy destination is in the storage system provided with the copy source volume or another storage system,
a copy destination storage that is the storage system provided with the copy destination volume is a storage system equivalent to or different from a copy source storage that is the storage system provided with the copy source volume,
the decryption key is the encryption key that is also used as a key for a decryption or a key separate from the encryption key, and
the computer program is used to make the computer carry out the following processing:
determining whether or not a security policy related to a copy destination volume is equal to a security policy related to a copy source volume based on the control information that includes information associated with a security policy related to the copy source volume and the copy destination volume;
configuring an encryption key/a decryption key related to the copy source volume as an encryption key/a decryption key related to the copy destination volume to the copy destination storage in the case in which a result of the determination is positive; and
indicating a copy of data from the copy source volume to the copy destination volume and an unencryption and an undecryption to the copy source storage and/or the copy destination storage.
